(19) United States
(12) Patent Application Publication
(10) Pub. No.: US 2004/0059617 A1
(43) Pub. Date: Mar. 25, 2004

(54) On-line athletic events management system and method

(75) Inventor: Thomas McGovern, Springfield, PA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Simplified Athletic Technologies, LLC d/b/a Leagueminder

(21) Appl. No.: 10/378,076

(22) Filed: Mar. 4, 2003

Related U.S. Application Data
(60) Provisional application No. 60/361,286, filed on Mar. 4, 2002.

(51) Int. Cl. G06F 17/60

(52) U.S. Cl. 705/8

(57) ABSTRACT

The invention provides an online athletic events management system and method that seeks to automate all internal and external components associated with planning, coordinating, and conducting athletic events. Organization and coordination functions for athletic events and leagues may be completed electronically through a network of computing platforms. These features allow athletic directors and league coordinators to plan and organize events and schedules in a more efficient and expedient manner.

### CROSS REFERENCE TO RELATED APPLICATIONS

This application claims priority under 35 U.S.C. § 119(e) to U.S. Provisional Patent Application No. 60/361,286, filed on Mar. 4, 2002, the disclosure of which is incorporated by reference in its entirety herein.

### BACKGROUND OF THE INVENTION

1. Field of the Invention

The invention relates to computer-based systems for events management and, in particular to an on-line athletics management system and method.

2. Description of the Related Art

Conventional systems for coordinating events require a significant amount of human effort in order to allow a large number of organizations to be able to interact with one another without overlapping of schedules and conflicting availability. In the area of managing the scheduling for athletic events, the coordinating of an entire season for a league having multiple teams can become an even more cumbersome task. When trying to coordinate a sports season, the coordinator must factor in a variety of factors, including the total number of teams in a league, the need for each team to play each other a certain number of times, the limited duration of the season, the desire for the season to start and end on the same day for all of the teams in the league, the availability of the sporting venue for a given day, the availability of necessary officials and referees to supervise the sporting event and the need to be able to alter scheduling in a quick manner in the event that such a change is required by adverse weather, the unavailability of a team or the unavailability of officials and/or referees to supervise the event.

Larger and well funded organizations, such as professional sports leagues, typically have the resources to grapple with the scheduling issue described above. In addition, professional sports leagues employ professional athletes whose availability during a sports season is expected. In contrast, amateur sports leagues, and in particular schools and colleges do not have the resources or captive athletes which make it easier to schedule athletic events. Thus, a simple and easily accessible system for coordinating all of the factors related to the scheduling of athletic events is desirable.

### SUMMARY OF THE INVENTION

The invention pertains to an online athletic events management system and methods that seeks to automate all internal and external components associated with planning, coordinating, and conducting athletic events. Organization and coordination functions for athletic events and leagues may be completed electronically through a network of computing platforms. These features allow athletic directors and league coordinators to plan and organize events and schedules in a more efficient and expedient manner. Internal communications between all support services associated with any athletic event, such as transportation, may be managed through the system according to the invention. The invention may be supported by a centralized database that stores information and data regarding league scheduling, contracts, statistics, and resource availability. The invention offers a public view of important information concerning the scheduling and organization of athletic events. These features should reduce the need to engage in time consuming and inefficient traditional means of communication.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a block diagram of an on-line athletic events management system in accordance with an embodiment of the invention;

FIG. 2 shows the functional modules that residing in the application computer of FIG. 1 in accordance with an embodiment of the invention;

FIG. 3 shows a process flow for online events management in accordance with an embodiment of the invention; and

FIG. 4 shows a process flow for online events management in accordance with another embodiment of the invention.

### DETAILED DESCRIPTION OF THE PREFERRED EMBODIMENTS

Reference will now be made in detail to the preferred embodiments of the invention, examples of which are illustrated in the drawings. This invention may, however, be embodied in many different forms and should not be construed as limited to the embodiments set forth herein. In addition and will be appreciated by one of skill in the art, the invention may be embodied as a method, data processing system or computer program product. Accordingly, the invention may take the form of an entirely hardware embodiment, an entirely software embodiment, or an embodiment combining software and hardware aspects. Furthermore, the invention may take the form of a computer program product on a computer usable storage medium having computer readable program code means embodied in the medium. Any suitable computer readable medium may be utilized including, but not limited to, hard disks, CD-ROMs, optical storage devices, and magnetic storage devices.

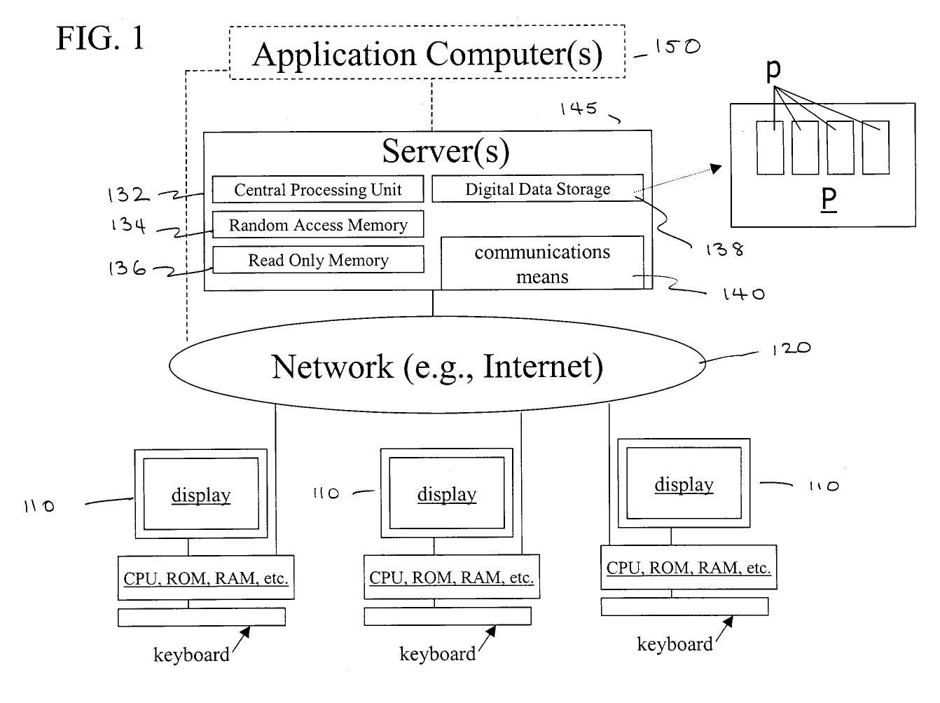

FIG. 1 shows a block diagram of a system for on-line event management in accordance with an embodiment of the invention. FIG. 1 shows one illustrative computer system in which embodiments of the invention can be employed, including a computer network (e.g., such as the world wide web, the Internet, a wide area network (WAN), an intranet, a virtual private network (VPN), any other network of computers, a combination of such networks, or the like) having at least one client computer (e.g., a personal computer, lap top computer, personal digital assistant or any other computer device or system) and at least one server for providing information to the client computers via the network. As shown, at least one application computer can be provided that is programmed to conduct analyses according to embodiments of the invention. The application computer(s), client computers and server(s) can include any appropriate computers. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. The client computers may contain browser software for interacting with the server(s), such as, for example, using hypertext transfer protocol (HTTP) to make requests of the server(s) via the Internet or the like.

Thus, FIG. 1 shows at least one user interface 110 coupled to a server 145 via a computer network 120. The server 145 may include a central processing unit 132, random access memory (RAM) 134, Read Only Memory (ROM) 136, a digital data storage unit 138 and communications means 140. An application computer is then coupled to the server 145. The functionality in accordance with the invention may reside at the application computer 150. Thus, users can access the application computer 150 via the computer network 120 and the server 145. Users can also submit information (e.g., text information, reports, responses, etc.) that can be retained in the digital data storage unit 138 of the server 145 and/or in one or more other computers. This information can then be analyzed via the application computer 150 as will be described in greater detail below.

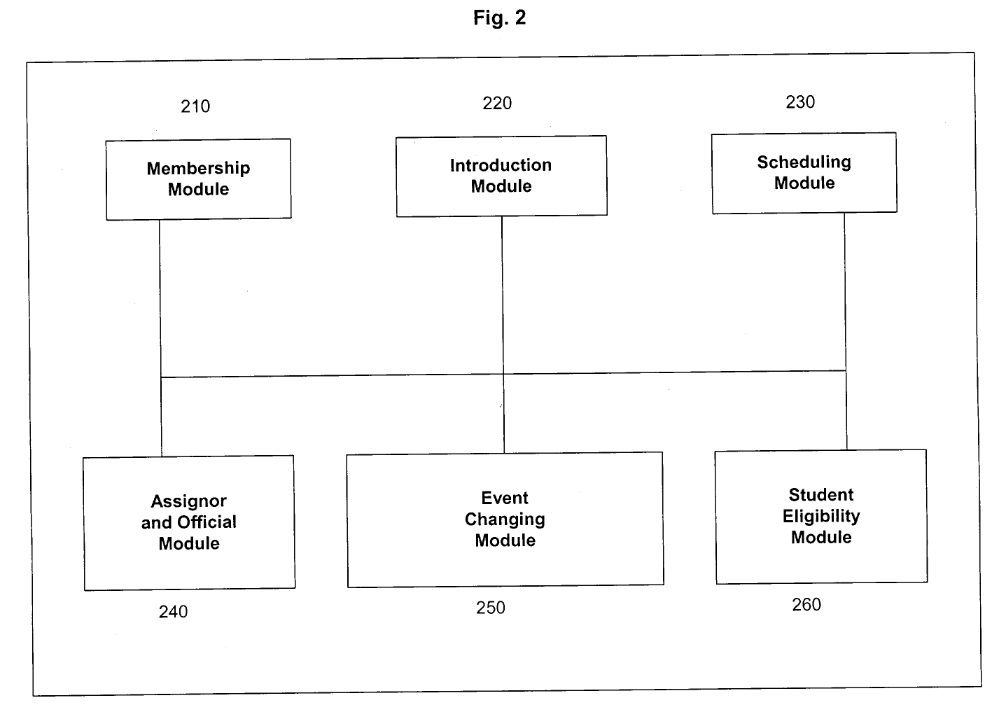

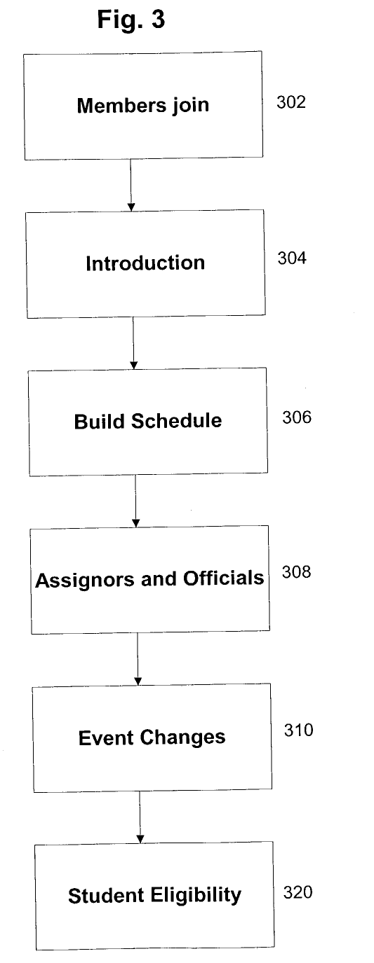

As described above, the system of FIG. 1 allows automation of all internal and external components associated with planning, coordinating and conducting athletic events. FIG. 2 illustrates the functional modules associated with an embodiment of the invention in greater detail. In FIG. 2, these functional modules are shown to reside in the application computer 150 shown in FIG. 1, however, it should be understood that this functionality may reside in any location accessible to a user via an electronic network. Thus, in FIG. 2, the system in accordance with an embodiment of the invention includes a membership module 210, an introduction module 220, a scheduling module 230, an Assignor or Official Module 240, an event changing module 250 and a student eligibility module 260. The functionality associated with each of these modules is described in greater detail below in connection with the process shown in FIG. 3, however, in general, the membership module 210 provides organizations the opportunity to become members of the on-line athletics management system in accordance with the invention. In FIG. 2, the introduction module 220 guides users through an introductory process where they can provide certain background information, provide facilities information, describe the sports offered, build a contacts list, highlight any scheduling conflicts and designate a “Chair” for a particular activity or sport.

FIG. 3 also shows a scheduling module 230. Two types of scheduling are governed by this module, the creation of a “master schedule” which is a global schedule of all organizations involved and a non-league games schedule. FIG. 3 also shows an Assignor and Officials module 240 which governs the assembling of a team of available officials to officiate at each scheduled event. Also, FIG. 3 illustrates an events changing module which provides functionality which allows members to cancel or re-schedule events and automatically informs opponents and officials of the schedule changes. FIG. 2 also shows a student eligibility module which allows eligibility information to be collected and exchanged between opponents automatically.

FIG. 3 illustrates a process for on-line athletic events management associated with an embodiment of the invention. In this embodiment, the organizations scheduling events are schools seeking to schedule a variety of sporting events over the course of an entire season. In FIG. 3, the process begins with step S302, where individuals, schools or organizations become members of the on-line athletics management system in accordance with the invention. After joining, the process moves to step S304.

In step S304, users may be guided through an introductory process whereby certain information may be requested. For example, the users may create a new password and reminder hint question. Users may also enter their contact information, such as their address, telephone number and/or e-mail address. Users may also enter member contact information related to whichever member that user is a part of. For example, if the member is a school, the user will enter contact information for the school. Information relating to the organization's facilities may also be entered into the system. For example, if the member is a school, one could enter whether the school has a swimming pool, a gym or a stadium, etc. The members can also enter the type of athletic organization to which they are a member. For example, if the member is a school, it can enter what type of athletic organizational governing body it is a part of. Members can also list out the type of events, offered. For example, if the member is a school, it can list out all of the sports offered by the school, for example, boy's soccer, girls swimming, etc. Members can also list build contacts lists and enter closed dates, i.e., dates for which activities are already scheduled or are not allowed. In this step, members can also select certain events to “Chair.” For example, in a sports league, one or more athletic directors may act as a Chairperson for a particular sport. This Chairperson may be responsible for building a “master schedule” for their league.

Once the introductory step S304 is completed, the process moves to step S306. In step S306, members can begin using the system to build roles. Users from a member school can select one of two roles, an Athletic Director or a Chairperson. An Athletic Director can create non-league games, while a Chairperson can create “master schedules.”

The process for creating “master schedules” is described first. First, in order to create a master schedule, the user must switch his or her role to that of a “Chairperson.” The user can then select the sport for which he or she would like to create the schedule. Next, the Chairperson can name a League Assignor for the sport. Assignors are responsible for assigning referees to each game. Next, the Chairperson can enter the fee amount paid to each official for a game and for a scrimmage. The Chairperson then can select the date and teams participating in each game. In accordance with the invention, teams will be pre-populated in a selection box based on the league setup process. Finally, after the schedule is completed, the system will notify all member schools through a messaging system. The messaging system may reside, for example, in the application computer 150 and provide notifications via a messaging system to the member schools user interface. Thus, schools will be notified of the scheduling via, for example, the user interface 110. Member schools receiving the notification will have the opportunity to approve or decline the schedule. If a member school accepts the games, the system now creates an electronic contract between the schools by populating electronic versions of State Game Contracts. If the member school rejects the contract, the opponent is notified.

The process by which an Athletic Director can create non-league games is now described in detail. First, a user selects the role of “Athletic Director.” Next, the Athletic Director, using the user interface 110, navigates to a “Sports Schedules” section. The Athletic Director then selects a sport for which he or she would like to create games. Then, the Athletic Director selects the date, times, venues, transportation arrangements and opponents. After the game has been entered, the system notifies opponents that a game has been created and needs approval. If the opponent is a member of the system, he or she will receive a message in their message box asking them to approve or decline the event. If accepted, the system then creates an electronic contract between the schools and populates electronic versions of the State Game Contracts. If the event is declined, the opponent is notified.

The process then moves to step S308, where Assignors and Officials are named. In step S308, the Officials are taken though an introductory process as they first log into the system. The Officials are asked to select sports they are certified to officiate and enter any conflicts in their schedule.

After the introductory process, the Officials then receive their assignments. When assigned games in accordance with the system, Officials are asked to approve the games assignments. If an official accepts a game assignment, a contract is created between the home school (where the event is taking place) by populating electronic versions of State Official Contracts.

Assignors are taken through an introductory process upon first logging into the system. They are first asked to provide contact information and then they select the sports they assign. After this introductory process, assignors can then build a pool of officials. These are the officials in their respective states who will be assigned to officiate certain games. Officials can be added to the pool via a search tool. Assignors have the option to rate officials and contests in order to better match them with the level of competition.

Once the games are approved, they appear in the queue of the named Assignor for that sport. Next, the Assignor will then have to select each game and select officials to work that game. The list of available officials will be populated based upon their availability. Availability is based upon the conflicts officials enter and the previously scheduled games. After the officials are selected, the system notifies each official via a messaging system in accordance with the invention which asks the official to approve the assignment. If the official rejects the assignment, then the Assignor is notified to re-assign the game to another official.

The process then moves to step S310 where event changes can be facilitated. At any time, members can have the ability to cancel or reschedule any game on the system. If the game is cancelled, the system notifies the parties involved by, for example, a messaging system, which would include the opponents, assignors and the officials. If a game is rescheduled, the opponent is notified and must accept or reject the change. If the change is rejected, the game remains as it was originally scheduled. If the change is approved, the Officials are notified of the change and asked to approve. If the Official approves the change, the contract is rewritten. If the Official declines the change, the Assignor is notified to re-assign the rescheduled contest. The process then moves to step S320.

In step S320, student eligibility information is compiled. In many states, the eligibility of students is required to be exchanged between opponents. The eligibility may depend upon a minimum grade point average, age or semester attended or any other criteria. In step S320, students can register with their school in order to pool eligibility information for a school's entire team. They may be asked to provide certain information, including but not limited to their name, birth date, grade, sports played and season of competition, in order to create a student profile. The system, using the student profile, matches the pertinent information to every sport in which that student may be participating. The Athletic Director can review and edit this information before sharing it with other schools. The system then automatically populate electronic versions of State Eligibility forms, which are then automatically exchanged with opponent schools. Thus, in this manner, eligibility information may be continuously updated and automatically exchanged between opponents. The eligibility information may also be assembled into a printed report that can be exchanged and reviewed between opponents.

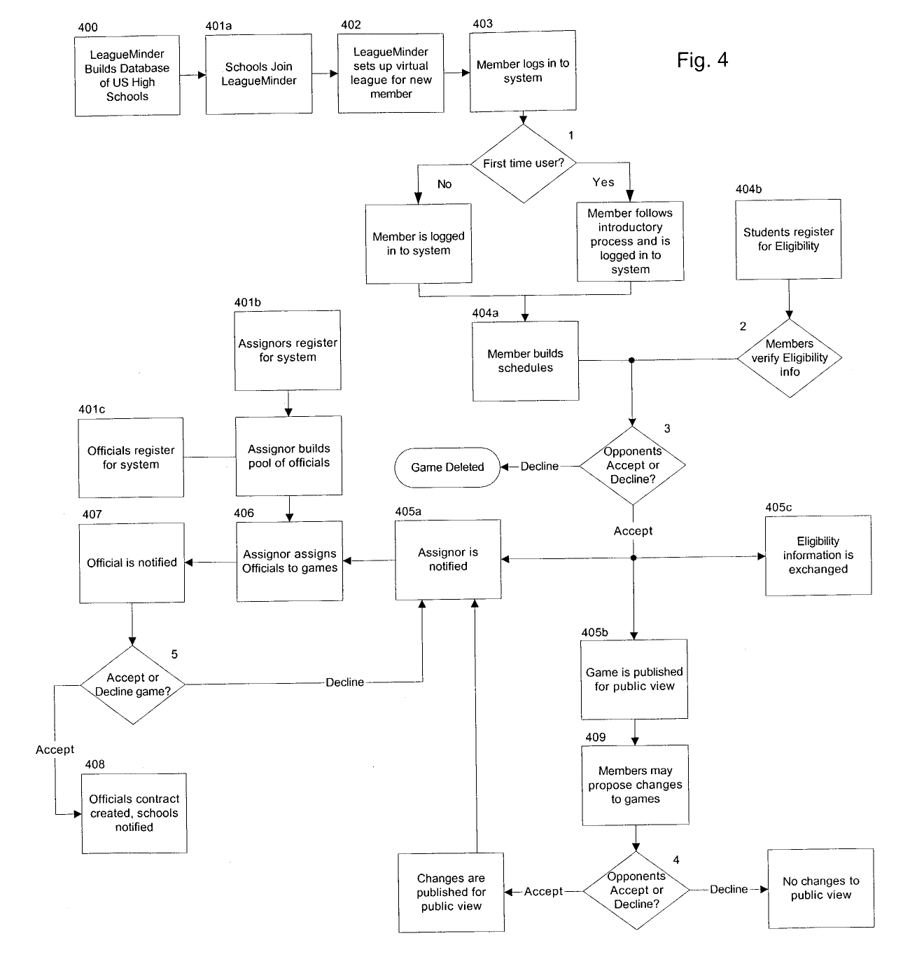

FIG. 4 shows a process for on-line management of athletic event in accordance with another embodiment of the invention. In this embodiment, a detailed process for scheduling sporting events for schools is described. In FIG. 4, the process begins with step S400 where the system builds a database of U.S. high schools. The process then moves to step S401a where schools join the system. The process then moves to step S402 where the system sets up a virtual league for new members.

The process then moves to step S403 where members log into the system. Next, at decision point 1, the member is queried as to whether he or she is a first time member. If the member is a first time member, the new member follows an introductory process and is logged into the system. If the member is an existing member, the member is logged into the system. The process then moves to step 404a where the member builds schedules. Alternatively, the process can begin at step 402b where students register for eligibility in which the system first verifies the eligibility information at decision point 2.

In either case, whether leaving step S404a or the decision point 2, the process then moves to decision point 3 where the system either accepts the member or declines. If declined, the process ends. Otherwise, the process moves to step 405c where the eligibility information is exchanged between opponents. Also, the process moves to step S405b where the game is published for public view. The process then moves to step S409 where members may propose changes to games. The process then moves to decision point 3 where opponents can either accept or decline the change requested. If declined, there are no changes to the public view. If accepted, the changes are published for public view. In either case, the process then moves to step S405a. In step S405a, the Assignor is notified. The process then moves to step S406 where the assignor assigns officials to games. This step is preceded by steps 401b and c where Assignors register for a system, Officials register for the system and the Assignor build a pool of officials. These actions are fed into step S406 where the Assignor assigns officials to games. The process then moves to step S407 where the official is notified of the game assignment. The process then moves to decision point 5 where the official can accept or decline the game. If accepted, the process moves to step S408 where the Officials contract is created and the schools are notified. If in decision point 5 the official declines the game, the process returns to step S405a where the Assignor is notified of a need for Officials. The process then ends.

According to the preferred embodiments, data, information, and/or commands may be entered at a client computer. The information and/or data may be entered via a graphical user interface that elicits the information and/or data from a user. Specifically, the information and/or data may pertain to scheduling, managing, planning, coordinating, and conducting athletic events. All these functions, plus any additional functions, may be executed electronically according to the preferred embodiments.

The disclosed processes are executed using a computer network system, as disclosed above. The information and/or data entered above may be stored on a central database. Software may be created to facilitate execution of the disclosed processes within the database and to display the results to the user on a client computer. Thus, public view of stored information regarding schedules, game results, statistics, resource availability, and the like may be enabled that potentially reduces the need to engage in time consuming traditional means of communication, such as numerous phone calls.

Information and/or data may be exchanged between the central server and the client computers via the mediums disclosed above. Thus, games and other events may be entered into the client computer, and then the pertinent information regarding the event may be stored at the central database. Other information also may be retrievable from the central database.

The central database preferably is a server having the features disclosed above. Alternatively, the central database may encompass more than one server that provides the disclose functionalities.

While the illustrated embodiment shows a client/server system, various other embodiments can include one or more computer. For example, one or more computers can include information in data storage that can be analyzed according to embodiments of the present invention. For example, data may be entered, stored and analyzed on a single computer in some embodiments. The manner in which information is obtained and/or stored, e.g., in digital data storage, may vary depending on circumstances. In some embodiments, a sniffer program could even be used to capture data being transmitted on a network, such as via a network router with a sniffer that reads data in packets along with, e.g., source and destination addresses.

In some embodiments, in order to conduct an analysis of information contained in digital data storage or databases, an HTTP interface can be provided to “text format” cases, while in other embodiments, direct access to underlying database(s) using, e.g., ORACLE 8 or the like can be provided and/or access to underlying files using NETWORK FILE SYSTEM™ (NFS) or the like can be provided. NFS is a client/server application that allows a user to view, store and/or update files on a remote computer as though they were on the user's own computer. In the latter instance, for example, the application computer(s) or the like could have an NFS client and the server(s) or the like could have an NFS server. Both of these may also have TCP/IP installed as versions of NFS server and client use TCP/IP to send files and updates back and forth.

As disclosed above, the disclosed preferred embodiments may include several features that are distinct from a conventional athletic event management system. The features include: an on-line state eligibility registration process with data later being converted to team lists, awards lists, transcript credit and the like; complete networking of an athletic league via the world wide web; on-line registration of officials with each chapter assignor; and synching throughout the world wide web of all updates and changes in athletic schedules with a visual indicator of change in status, electronic exchange of athletic contracts between schools, and electronic exchange of officials' contracts between the schools and officials.

The features of the invention also include: electronic exchange of eligibility information; electronic notification of a proposed change to those associated with an athletic event; electronic schedule building tool designed for quick scheduling of league contests; an electronic assigning tool enabling assignors to match officials with scheduled contests; electronic notification of officials as to others working at scheduled contest and pertinent information, such communication information, telephone numbers, emails, and the like.

Additional features include: electronic blocking out of portions of a day or entire days to prevent scheduling conflicts, such as scheduling a game on the same evening as a school dance or event; electronic requisitioning of transportation requests; allowing users the ability to query the system data via multiple avenues to create reports of open dates or schools with game availability; allowing users to view athletic schedules and school information of other the system members with one the system site; having the system to create league-wide public and private bulletin boards; and the ability to submit early dismissal reports to principals to get authorization to leave classes due to scheduled athletic events.

Further features include: the ability for assignors to rate officials by their ability and/or experience, to rank the difficulty level of the contest, and to match the more experienced and/or skilled officials with the more difficult contests; in addition to the ability of the disclosed system to send electronic notifications of a proposed change, the disclosed system also may send notifications to each party involved when a contest originally is created; the disclosed system may notify the initiator of a change as to whether the proposal was accepted or declined; the ability to block out an entire school, a particular team, or a particular facility for reasons such as holidays, exams, dances, maintenance, and the like when considering electronic blacking out of dates.

Additional features include a facility management tool that enables users to view a schedule for a particular facility; the ability to use the disclosed embodiments to requisition game security or medical staff in the same manner as transportation requests may be made; producing directions and maps for each school on the disclosed system such that the public and other schools may view directions and maps; and allowing a school to identify additional features of its facilities. This feature may allow a school to state whether a facility has parking, handicap access, water fountains, restrooms, vending machines, snack bars, telephones, seating, and the like. Features also include: displaying the details of a particular contest, such as date, time, venue, parking, vending, map, directions, and the like, when someone views the information over the disclosed system.

It will be apparent to those skilled in the art that various modifications and variations can be made in the present invention without departing from the spirit or scope of the invention. Thus, it is intended that the present invention covers the modifications and variations of this invention that come within the scope of any claims and their equivalents.

1. A system for the on-line management of events, comprising:
a membership module;
a build schedule module; and
an event changes module, wherein each of the modules are communicatively coupled to one another.

2. The system according to claim 1, further comprising:
an introduction module;
an Assignors and Officials set-up module; and
an eligibility module, wherein each of the modules are communicatively coupled to each other.

3. The system according to claim 1, wherein the events are athletic events.

4. The system according to claim 1, wherein the system is accessible by a plurality of users via a communications network.

5. The system according to claim 1, wherein the build schedule module allows an athletic director to select a sport for which to build a schedule and select at least one of a date, a time, a venue, a transportation arrangement and an opponent.

6. The system according to claim 5, wherein the build schedule module notifies an opponent that a game has been created, requests approval from the opponent and performs on of notifying the opponent of a declination or creates an electronic contract between two opponents depending upon whether an opponent has approved or disapproved the request for approval.

7. The system according to claim 1, wherein the build schedule module allows a chairperson to select a sport for scheduling, names a league assignor responsible for assignment of referees, select dates and teams for participation and notifies all member schools of the schedule.

8. The system according to claim 7, wherein the build schedule module requests an approval from each member school for the proposed schedule and performs one of creating an electronic contract between opponents and notifying an opponent of a rejection of the schedule depending upon a response to the request for approval.

9. The system according to claim 1, wherein the event change module allows members to cancel or reschedule any game on the system, notify an affected party of a cancellation and request rescheduled date.

10. The system according claim 2, wherein the introduction module allows users to enter their respective contact information, facilities information, events offered information, conflicted dates and make a selection of a chairperson for building a master schedule.

11. The system according to claim 2, wherein the Assignor and Officials set-up module allows an assignor to generate a pool of eligible and available officials for refereeing events, query each official as to their availability for a specific event and notify each official of their assignment based upon their availability.

12. The system according to claim 2, wherein the check eligibility module compiles data from each student participating in an event, determines their eligibility based upon predetermined criteria and exchanges eligibility information between opponents.

13. A method for on-line management of events, comprising the steps of:
receiving membership information from at least one member;
receiving introductory information from the at least one member; and
building a schedule based upon the received membership and introductory information.

14. The method according to claim 13, further comprising the step of establishing Assignors and Officials for the events.

15. The method according to claim 13, further comprising the step of determining changes in an event.

16. The method according to claim 13, further comprising the step of determining the eligibility of each athlete.

17. The method according to claim 13, wherein the event refers to one of an athletic event and an entire season for a sport.

18. The method according to claim 13, wherein the step of receiving introductory information includes the steps of:
receiving corresponding contact information for each member;
receiving information relating to facilities;
receiving information relating to sports offered;
building a contact list based upon the received contact information;
receiving a list of conflicted dates; and
selecting a chairperson for building a league schedule.

19. The method according to claim 13, wherein the step of building a schedule includes:
creating an athletic director; and
creating a chairperson.

20. The method according to claim 19, wherein the chairperson creates a master schedule of games.

21. The method according to claim 19, wherein the athletic director creates non-league games.

22. The method according to claim 20, wherein the step of creating a master schedule of games includes:
selecting a sport for scheduling;
naming an Assignor for the selected sport;
selecting a date and opponents for participation on each selected date;
notifying each opponent of the selected date; and
determining whether each opponent accepts the schedule.

23. The method according to claim 21, wherein the step of creating non-league games includes the steps:
selecting a sport for creating games;
selecting at least one of a date, a time, a venue, transportation arrangements and opponents; and
notifying each opponent of the selected date; and
determining whether each opponent accepts the schedule.

24. The method according to claim 22, wherein the step of naming an Assignor includes the steps of:
selecting at least one sport to be assigned;
building a pool of qualified and available officials;
assigning each official to at least one athletic event;
notifying each official of the assignment step; and
offering each official the option of declining the option.

25. The method according to claim 15, wherein the determining step includes:
receiving input from at least one opponent requesting one of a rescheduling or cancellation;
notifying a corresponding opponent and an Assignor of the received input;
receiving rescheduling information from the at least one opponent;
querying the corresponding opponent and the Assignor in or to seek their approval of the rescheduling information.

26. The method according to claim 16, wherein the step of determining the eligibility of each student includes the step of:
receiving information from each athlete participating in a scheduled event;
receiving a minimum qualifications requirement;
determining whether each athlete meets the minimum qualifications;
populating an eligibility form with the eligibility determination; and
exchanging the eligibility information between opponents.

27. A computer program product for the on-line management of athletic events, the computer program product including a computer usable storage medium having computer readable program code means embodied on the medium, the computer program product executing the steps of:
receiving membership information from at least one member;
receiving introductory information from the at least one member; and
building a schedule based upon the received membership and introductory information.
